(19) United States
(12) Patent Application Publication
(10) Pub. No.: US 2022/0143754 A1
(43) Pub. Date: May 12, 2022

(54) LASER ENGRAVING DEVICE, LASER ENGRAVING METHOD, AND DEVICE AND METHOD FOR MANUFACTURING CAN LID HAVING TAB

(71) Applicant: TOYO SEIKAN CO., LTD., Tokyo (JP)

(72) Inventors: Takeshi HORI, Kanagawa (JP); Tomohiko HORI, Kanagawa (JP); Atsushi KOMINAMI, Kanagawa (JP); Saki CHIJI, Kanagawa (JP); Hitoshi SAGAWA, Tokyo (JP); Ryotaro ISOMURA, Chiba (JP); Hideki ISHIGURO, Tokyo (JP)

(73) Assignee: TOYO SEIKAN CO., LTD., Tokyo (JP)

(21) Appl. No.: 17/439,099

(22) PCT Filed: Mar. 4, 2020
(86) PCT No.: PCT/JP2020/009116

§ 371 Date: Sep. 14, 2021

(30) Foreign Application Priority Data
Mar. 19, 2019 (JP) 2019-051707
Mar. 19, 2019 (JP) 2019-051713
Mar. 19, 2019 (JP) 2019-051717

(51) Int. Cl. B23K 26/364

(52) U.S. Cl. CPC B23K 26/364

(57) ABSTRACT

It is configured such that, for performing variable engravement for each formed object on a coil material to be fed to a press machine for molding a part of a can, a formed object with an engravement can be molded at a high productivity. A laser engraving device is a device for performing laser engraving on a coil material to be fed to a press machine for molding a part of a can, and includes a feeding mechanism for deeding a coil material at a predetermined speed, a laser head for irradiating the coil material fed at the predetermined speed with a laser beam, and performing engravement for each formed object, and a data communication unit for switching engraving data of the laser head. The data communication unit collectively switches a plurality of engraving data to be subjected to engravement on a plurality of formed objects, and the laser head continuously performs engravement of the plurality of engraving data on predetermined positions of the coil material.

### TECHNICAL FIELD

The present invention relates to a laser engraving device and a laser engraving method for performing laser engraving on a coil material to be fed to a press machine for molding a part of a can, and a manufacturing device and a manufacturing method for manufacturing a tabbed can lid subjected to laser engraving.

### BACKGROUND ART

A can is imparted with information, a pattern, or the like on a part on a part thereof, thereby being enhanced in decoratability, providing information of the individual product, and advertising the individual product. Out of these, the tab for opening the can lid is the site particularly attracting attention of a person holding a can when the person performs an opening operation. In the case of a stay-on tab type, the tab is not detached from the can lid main body. For this reason, by imparting information, a pattern, or the like to the part, it is possible to effectively enhance the decoratability, and to effectively provide information of the individual product.

For imparting information, a pattern, or the like to a can, laser engraving (laser marking) is adopted in which the coating film provided on the surface of the can, or the surface of the can is directly irradiated with a laser beam for performing engravement. For the engravement to the tab, laser engraving is adopted. As a result, high-resolution engravement can be performed in a relatively smaller space. A device for performing laser engraving on a coil material to be molded into a part of a can (laser engraving device) is equipped with a laser head between the roll of the coil material including a band-shaped sheet material wound in a roll form and a press machine to which the coil material drawn from the roll is fed. Before performing molding by the press machine, the coil material to be fed to the press machine is subjected to laser engraving at a prescribed position thereof (see the following PTL 1.

### CITATION LIST

### Patent Literature

[PTL 1] Japanese Translation of PCT Application No. 2015-531684

### SUMMARY OF INVENTION

### Technical Problem

Such a laser engraving device is required to perform variable engravement of performing engravement of different contents for each formed object. In order to perform variable engravement, it becomes necessary to communicate engraving data for each formed object, and to switch the operation program of a laser head. At this step, time is taken to switch the engraving data. The total time of the time actually required for the laser head to perform engravement of the contents of one engraving data and the time required for switching engraving data for each formed object restricts the time per press stroke for feeding the coil material to a press machine. This restriction has been an obstacle to mold a formed object with an engravement at a high productivity.

Further, such a laser engraving device includes a feeding mechanism for feeding a coil material to a press machine. The feed speed of the coil material to be fed to the press machine is adjusted by speed control of the feeding mechanism. In contrast, when the feed speed of the feeding mechanism changes, looseness becomes more likely to be caused in the coil material at a site provided with a laser head. Undesirably, the looseness causes an error in the engraving position on the coil material, or distortion in a letter, or the like to be subjected to engravement.

Particularly, when laser engraving is performed on both surfaces of the coil material, one surface of the coil material cannot be supported on a base. For this reason, the portion of the coil material facing the laser head hangs in the air, so that the foregoing looseness becomes more likely to be caused. For this reason, when laser heads are disposed on the front and back sides of the coil material, and laser engraving is performed on both the surfaces, the foregoing problem becomes more noticeable.

Further, for laser engraving on a part of a can such as a tab, after performing laser engraving on a coil material, a tab or the like is molded by a press machine. Accordingly, in the case where the mold die of the press machine is changed, or in other cases, a shift may be caused between the position to be subjected to engravement and an actual engraving position in the formed object such as a tab, which has entailed a problem that time and effort are required for correcting the shift.

Further, in the related art, before a coil material is fed to a press machine, the positioning mark imparted on the coil material and the engraving position are detected, thereby controlling the engraving timing of the laser head. According to this, in the case where the position adjustment of the press die is necessary, or in other cases, the shift between the position to be subjected to engravement and the actual engraving position in the formed object cannot be corrected with precision undesirably.

Further, when the product after molding has flaw or dirt, the product becomes a defective product. For this reason, when the engraving position is detected before feeding the coil material to the press machine as with the foregoing related art, the inspection of flaw or dirt of the product is performed separately from the detection of the engraving position. This undesirably results in complicated inspection step and system configuration for inspection.

It is an object of the present invention to deal with such problems. Namely, the objects of the present invention are to enable molding of a formed object with an engravement at a high productivity for performing variable engravement for each formed object on a coil material to be fed to a press machine for molding a part of a can; to enable high-precision engravement to be performed by suppressing the looseness of the coil material even when the feed speed of the coil material changes for performing engravement for each formed object on a coil material to be fed to a press machine for molding a part of a can; to enable precise and rapid correction of the shift between the position to be subjected to engravement and the actual engraving position in the formed object; and to enable simplification of the inspection step including the inspection of the engraving position and the inspection of flaw or dirt of a product after molding, and the inspection system.

### Solution to Problem

In order to solve such problems, the present invention includes the following configurations.

A device for performing laser engraving on a coil material to be fed to a press machine for molding a part of a can: the device is characterized by including: a feeding mechanism for feeding the coil material at a predetermined speed; a laser head for irradiating the coil material fed at a predetermined speed with a laser beam, and performing engravement for each formed object; and a data communication unit for switching engraving data of the laser head, and is characterized in that the data communication unit collectively switches a plurality of engraving data to be subjected to engravement on a plurality of formed objects, and that the laser head continuously performs engravement of the plurality of engraving data on each prescribed position of the coil material.

An engravement method for performing laser engraving on a coil material to be fed to a press machine for molding a part of a can: the method is characterized by including: a laser engraving step of irradiating the coil material fed at a predetermined speed to the press machine with a laser beam, and performing engravement on each formed object; and a data communication step of switching engraving data of the laser head, and is characterized in that in the data communication step, a plurality of engraving data to be subjected to engravement on a plurality of formed objects are collectively switched, and that in the laser engraving step, a plurality of engraving data are continuously subjected to engravement on positions at which the formed objects are respectively molded.

An engraving device for performing laser engraving on a coil material to be fed to a press machine for molding a part of a can: the device is characterized by including: a feeding mechanism for feeding the coil material at a predetermined speed; and a laser head for irradiating the coil material fed at the predetermined speed with a laser beam, and performing engravement for each formed object, and is characterized in that the feeding mechanism includes: a feed roll provided on a downstream side in a coil material feed direction of the laser head, and for controlling a feed speed of the coil material; and a tension roll provided on an upstream side in the coil material feed direction of the laser head, and for applying a tension to the coil material, and the tension roll performs torque control of a motor for driving the roll so that a load imposed on the roll may become constant.

An engraving device for performing laser engraving on a coil material to be fed to a press machine for molding a part of a can: the device is characterized by including: a feeding mechanism for feeding the coil material to the press machine at a predetermined speed; a laser head for irradiating the coil material fed at a predetermined speed with a laser beam, and performing engravement for each formed object; an inspection camera for shooting the formed object discharged from the press machine, and obtaining an image for inspecting an engraving position in the formed object; and a control unit for processing the image obtained by the inspection camera, determining a shift amount between a position to be subjected to engravement and an actual engraving position, and controlling an engraving timing of the laser head according to the shift amount.

A device for manufacturing a tabbed can lid is characterized by including: a press machine for performing molding of a tab and performing molding of a can lid, and performing binding of the molded tab and can lid; a feeding mechanism for feeding a coil material at a predetermined speed to the press machine; a laser head for irradiating the coil material fed at the predetermined speed with a laser beam, and performing engravement on each tab to be molded; an inspection camera for shooting a tabbed can lid after molding discharged from the press machine, and obtaining an image for inspecting an engraving position in a molded tab; and a control unit for processing the image obtained by the inspection camera, and determining a shift amount between a position to be subjected to engravement and an actual engraving position, thereby controlling an engraving timing of the laser head according to the shift amount.

A method for manufacturing a tabbed can lid is characterized by including: feeding a coil material at a predetermined speed to a press machine; irradiating the coil material fed at the predetermined speed with a laser beam, and performing engravement on each tab to be molded by a laser head; performing molding of the tab, and performing molding of a can lid, and performing binding of the molded tab and can lid by the press machine; shooting a tabbed can lid after molding discharged from the press machine, and obtaining an image for inspecting an engraving position in the molded tab; and processing the obtained image, and determining a shift amount between a position to be subjected to engravement and an actual engraving position, thereby controlling an engraving timing of the laser head according to the shift amount.

### Advantageous Effects of Invention

The laser engraving device of the present invention having such features can collectively switch a plurality of engravements for respective formed objects. For this reason, also when variable engravement for each formed object is performed, a formed object with an engravement can be molded at a high productivity by setting the time per press stroke as a short time.

Even when the feed speed of the coil material changes for performing engravement for each formed object on the coil material to be fed to a press machine for molding a part of a can, high-precision engravement can be performed by suppressing the looseness of the coil material.

It is possible to correct the shift between the position to be subjected to engravement and the actual engraving position in a formed object with precision and rapidly.

Further, the product image of a tabbed can lid is obtained by an inspection camera. For this reason, with the obtained image, it is possible to perform the inspection of an engraving position or of flaw or dirt of a product after molding in a unified way. This can simplify the inspection step and the inspection system.

### BRIEF DESCRIPTION OF DRAWINGS

FIG. 1 is an explanatory view showing a schematic configuration of a system for molding a tabbed can lid.

FIG. 2 is an explanatory view showing a configuration of a laser engraving device of a first embodiment.

FIG. 3(a) is an explanatory view for illustrating an engraving data switching system (an individual communication system).

FIG. 3(b) is an explanatory view for illustrating an engraving data switching system (a collective communication system).

FIG. 4 is an explanatory view showing one example of a laser engraving method.

FIG. 5 is an explanatory view showing the transfer of the engraving position in FIG. 4.

FIG. 6 is an explanatory view showing another example of the laser engraving method and is an explanatory view showing the operation chart thereof.

FIG. 7 is an explanatory view showing a configuration of a laser engraving device of a second embodiment.

FIG. 8 is an explanatory view for illustrating the tension control of a coil material.

FIG. 9 is an explanatory view for illustrating tabbed can lid manufacturing device and manufacturing method of a third embodiment.

FIG. 10 is an explanatory view showing a configuration of a laser engraving device.

FIG. 11 is an explanatory view showing an image of the tabbed can lid imaged by an inspection camera.

FIG. 12 is an explanatory view showing images of the tabbed can lid imaged by an inspection camera (two images under different shooting conditions).

### DESCRIPTION OF EMBODIMENTS

Below, the embodiments of the present invention will be described by reference to the accompanying drawings. In the following description, the same reference numerals and signs in different drawings denote the sites of the same function, and an overlapping description on respective drawings is appropriately omitted. Incidentally, in the following description, a description will be given by taking the tab of the can lid as an example as the formed object. However, the present invention is not limited thereto. A part of a can such as a can lid itself molded from the coil material, a can body, or a metal cap is targeted.

### First Embodiment

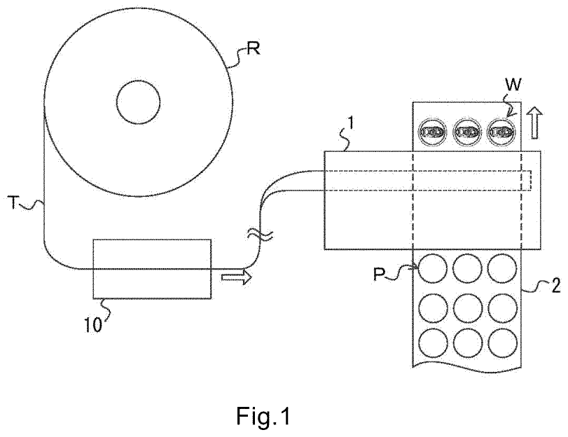

First, referring to FIG. 1, a schematic configuration of a system for molding a tabbed can lid will be described. In this example, a press machine (conversion press) 1 for performing molding a tab/processing a lid/binding the lid and the tab is used. A coil material T molded into tabs is a band-shaped sheet material of an aluminum sheet, and is drawn from a roll R wound in a roll form, and is fed to the press machine 1 at a predetermined speed. With the press machine 1, tab molding with respect to the coil material is performed, and processing of a can lid panel P to be fed by an another-rout conveyer 2 is performed. Thus, a can lid product W with the molded tab bound to the processed can lid is fed from the outlet of the press machine 1.

Incidentally, in the example shown, as the press machine 1, the one for performing conversion press is exemplified. However, the present invention is not limited thereto. The following configuration is also acceptable: with the press machine 1, only a tab is molded, and with another press machine, a can lid is molded, which is bound with the tab (the one not separated from the coil material) molded with the press machine 1.

A laser engraving device 10 for imparting an engravement on a tab is disposed with respect to a coil material T drawn from a roll R, and to be fed to the press machine 1. The laser engraving device 10 performs laser engraving on a prescribed position corresponding to the stroke of the press machine 1 for the coil material T before being subjected to molding of a tab.

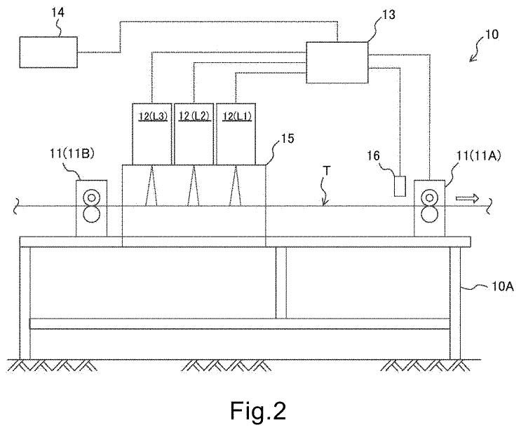

As shown in FIG. 2, the laser engraving device 10 includes a feeding mechanism 11 (a feed roll 11A and a tension roll 11B) for feeding the coil material T in the direction of an arrow at a predetermined speed, a laser head 12 (a first laser head L1, a second laser head L2, and a third laser head L3) for irradiating the coil material T that is fed at a predetermined speed with a laser beam and performing engravement on each tab to be molded, a control unit 13 for controlling the laser head 12, and a data communication unit 14 for switching engraving data with respect to the laser head 12.

In the example shown, the laser engraving device 10 includes a base unit 10A. On the base unit 10A, the feeding mechanism 11 or a laser irradiation unit 15 equipped with the laser head 12 is disposed. Further, the control unit 13 and the data communication unit 14 are disposed on a control board or the like not shown disposed on the base unit 10A.

The laser engraving device 10 is equipped with a speed sensor 16 for measuring the feed speed of the coil material T. For the speed sensor 16, a laser doppler speed meter for irradiating the coil material T with a laser beam, and measuring the feed speed of the coil material T in a non-contact manner can be used. The output from the speed sensor 16 is transmitted to the control unit 13, and the feed amount (distance) is calculated from the measured feed speed. The control unit 13 controls the engraving timing of the laser head 12 according to the output (the feed amount of the coil material T) of the speed sensor 16, and performs the control so that engravement is performed on a prescribed position of the coil material T.

The laser head 12 performs engravement for each individual tab according to the engraving data switched by the data communication unit 14. In the example shown, the laser head 12 includes a plurality of laser heads (three laser heads L1, L2, and L3) provided therein, and the data communication unit 14 individually switches the engraving data for each laser head 12.

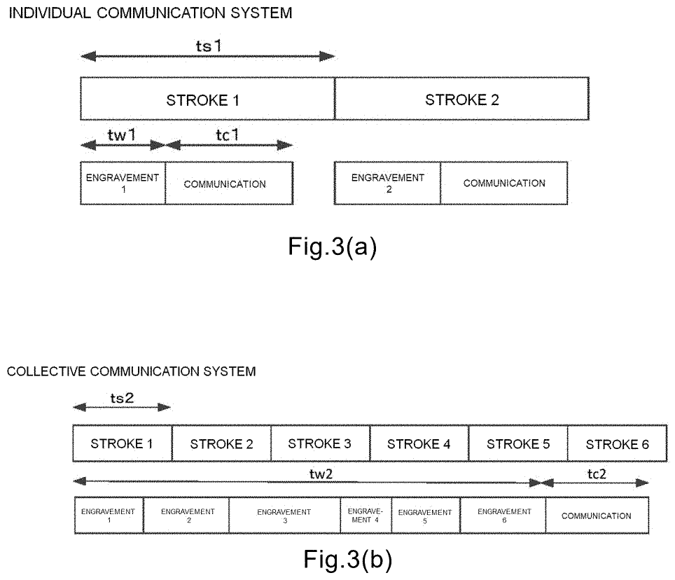

Then, the data communication unit 14 of the laser engraving device 10 switches the engraving data of the laser head 12 not by the individual communication system as shown in FIG. 3(a) but by the collective communication system as shown in FIG. 3(b). In the case of the individual communication system shown in FIG. 3(a), the inter-stroke time ts1 of press mold is required to be taken longer than the total time (tc1+tw1) of the communication time tc1 required for switching the engraving data necessary for performing the next engravement (e.g., “engravement 2”) and the time tw1 necessary for actually performing one engravement (i.e., tc1+tw1<ts1). For this reason, there is a limit on shortening of the inter-stroke time ts1, so that a tab with an engravement cannot be molded with a high productivity.

In contrast, when the collective communication system shown in FIG. 3(b) is adopted, a plurality of (six in the example shown) engraving data can be switched for one communication time tc2. For this reason, it is essential only that the total time (tc2+tw2) of one communication time tc2 and the time tw2 required for continuously performing a plurality of engravements (engravement 1 to engravement 6) falls within the time necessary for a plurality of strokes (stroke 1 to stroke 6). Accordingly, the inter-stroke time (ts2) can be set short. As a result, a tab with an engravement can be molded at a high productivity.

A plurality of engraving data to be communicated with the collective communication system can include different engravement contents so as to be adapted to each tab. At this step, when complicated engravement requiring a relatively longer engravement time is included in the plurality of engravement contents, combination with the engravement contents requiring a short engravement time enables inclusion of the complicated engravement contents without elongating the stroke time.

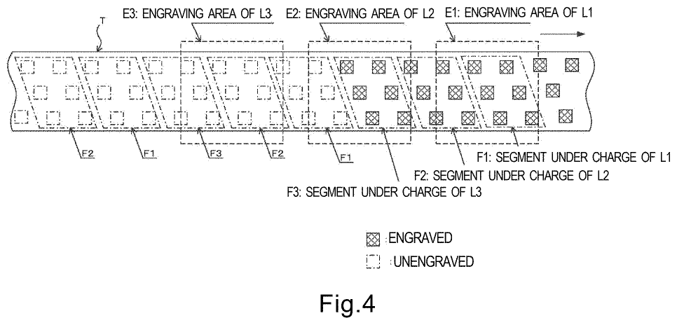

FIG. 4 shows a laser engraving method when tabs each with an engravement are molded at a high productivity using the three laser heads 12 (L1, L2, and L3). In this example, with the plurality of laser heads 12 (L1, L2, and L3), the engraving positions (F1, F2, and F3) under charge of respective laser heads are sequentially segmented along the feed direction of the coil material T. In the example shown, the positions to be continuously subjected to a plurality of (6) engravements are assumed to be one segment. The segment (F1) under charge of the laser head L1, the segment (F2) under charge of the laser head L2, and the segment (F3) under charge of the laser head L3 are arranged sequentially along the feed direction of the coil material T. Namely, the segment of F2 is set adjacent to the segment of F1, and the segment of F3 is set adjacent to the segment of F2 toward the opposite side to the feed direction of the coil material T.

With respect to such setting of the engraving positions on the coil material T, the plurality of laser heads 12 (L1, L2, and L3) are arranged along the longitudinal direction of the coil material T, and the engraving areas E1, E2, and E3 of respective laser heads L1, L2, and L3 are set in a fixed state along the longitudinal direction of the coil material T. The “engraving area” herein referred to denotes the range in which one laser head can perform engravement.

Herein, respective laser heads L1, L2, and L3 each continuously perform a plurality of (6) engravements on prescribed positions in the segment when a plurality of (6) engraving data are collectively switched, and respective segments (F1, F2, and F3) of their respective own assigned engraving positions come to the prescribed positions of respective their own engraving areas (E1, E2, and E3).

The operations of the laser heads L1 will be described individually. The coil material T is fed in the direction of an arrow shown, and the segment F1 enters the engraving area E1, and a plurality of engravements are continuously performed by the laser head L1. Immediately thereafter, the segment F2 under charge of the laser head L2 and the segment F3 under charge of the laser head L3 sequentially enter the engraving area E1 (at the previous stage, the segments F2 and F3 have already been subjected to engravement). The operations of the laser heads L2 and L3 are the same.

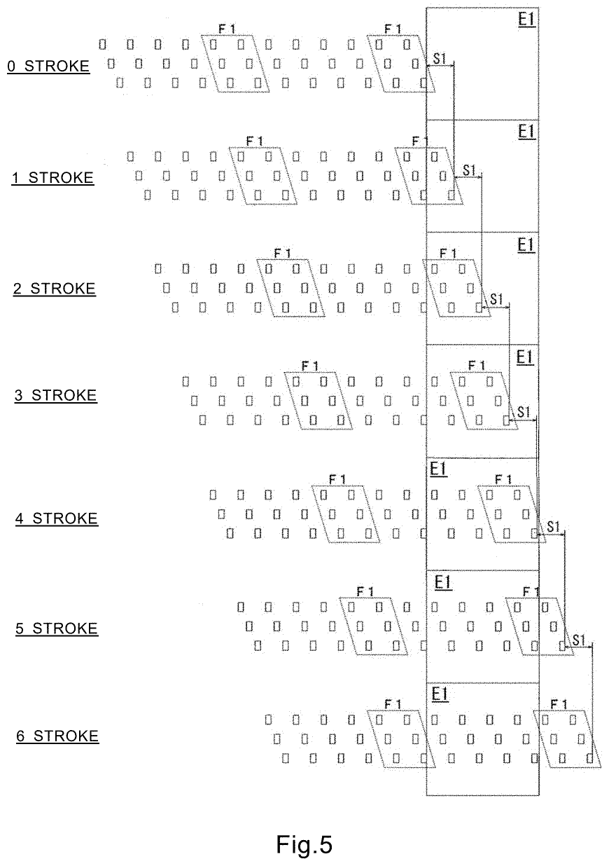

FIG. 5 shows the transfer of the engraving position of the example shown in FIG. 4. The transfer distance of the coil material T depends upon the stroke of the press. The transfer distance of the coil material T for one stroke is set at S1 in the example shown. As shown, the number of strokes between entering and leaving of the entire segment (F1) into and from one engraving area (E1) is 6, and the number of strokes and the number of the engraving data in one engraving position segment (F1) are set so as to be the same.

Then, one laser head 12 performs engravement of a plurality of (6) engraving data to be subjected to engravement at each segment during the period during which the engraving position segment F1 under charge of the laser head itself passes through the engraving area E1 of the laser head itself, and engraving data is switched until the next engraving position segment under charge of the laser head itself enters into the engraving area of the laser head itself.

With such an engravement method, a plurality of laser heads are disposed along the feed direction of the coil material, and the engraving position segments under charge of respective laser heads are segmented sequentially along the feed direction of the coil material T. As a result, even if the stroke time of the press is set short, variable engravement for each tab can be performed smoothly.

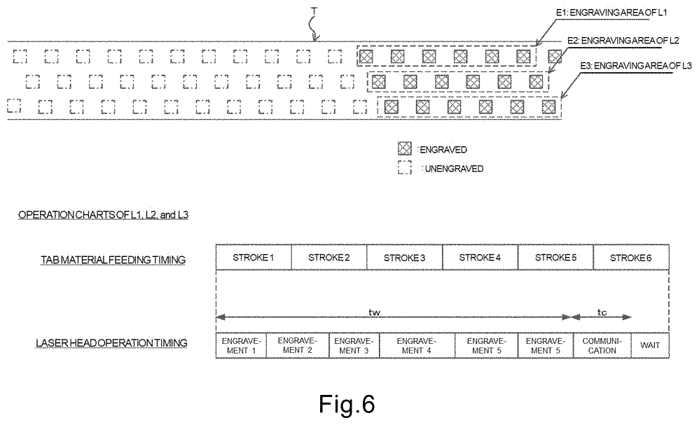

FIG. 6 shows another engravement method when tabs each with an engravement are molded using 3 laser heads 12 (L1, L2, and L3) at a high productivity. In this example, the plurality of laser heads 12 (L1, L2, and L3) are arranged for each row of the tabs to be molded from the coil material T, and the engraving positions under charge of respective laser heads are segmented for each row of the tabs to be molded. Specifically, the engraving area E1 of the laser head L1, the engraving area E2 of the laser head L2, and the engraving area E3 of the laser head L3 are arranged in parallel with their respective three rows of tabs to be molded, respectively.

According to this, in order for each laser head (L1, L2, or L3) to continuously perform engravement of a plurality of (e.g., six) engraving data at prescribed positions, it becomes necessary to allow the time tw for a plurality of engravements (engravement 1 to engravement 6) and the communication time tc for collectively switching a plurality of engraving data for performing the next engravement to fall within the time for a plurality of strokes (6 strokes) as in the operation chart shown in FIG. 6.

According to this, one base of laser head is allowed to deal with each row of the tabs to be molded. For this reason, the engraving position of each row can be corrected with each laser head. Further, the laser head to be corrected when an engravement error is caused becomes more likely to be identified. These and other advantages in terms of control and management become more likely to be obtained.

As described up to this point, with the engraving device and the engravement method of a tab in accordance with the first embodiment of the present invention, even when the inter-stroke time of the press machine for tab molding is shortened, thereby enhancing the productivity, it is possible to smoothly perform variable engravement on the coil material. Accordingly, it becomes possible to perform engravement on the coil material while changing various patterns and information as needed without reducing the productivity.

### Second Embodiment

Also in a second embodiment, the description thereon is common to that of FIG. 1.

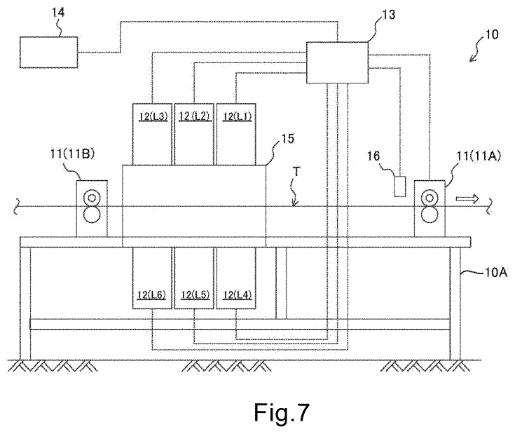

In the second embodiment, as shown in FIG. 7, a laser engraving device 10 includes a feeding mechanism 11 (a feed roll 11A and a tension roll 11B) for feeding a coil material T in the direction of an arrow at a predetermined speed, laser heads 12 (a first laser head L1, a second laser head L2, a third laser head L3, a fourth laser head L4, a fifth laser head L5, and a sixth laser head L6) for irradiating the coil material T fed at the predetermined speed with a laser beam, and performing engravement for each tab to be molded, a control unit 13 for controlling the laser heads 12, and a data communication unit 14 for switching the engraving data with respect to the laser heads 12.

In the example shown, the laser engraving device 10 includes a base unit 10A. On the base unit 10A, the feeding mechanism 11, or a laser irradiation unit 15 equipped with the laser heads 12 is disposed. Further, the control unit 13 and the data communication unit 14 are disposed on a control board or the like not shown disposed on the base unit 10A.

The laser engraving device 10 is equipped with a speed sensor 16 for measuring the feed speed of the coil material T in a non-contact manner. The speed sensor 16 is provided in the vicinity of the feed roll (preferably, between the feed rolls 11A and 11B). A laser doppler speed meter for irradiating the coil material T with a laser beam, and measuring the feed speed of the coil material T in a non-contact manner can be used. The output from the speed sensor 16 is transmitted to the control unit 13, and the feed amount (distance) is calculated from the measured feed speed. The control unit 13 controls the engraving timing of the laser heads 12 according to the output (the feed amount (distance) of the coil material T) of the speed sensor 16. Alternatively, the control unit 13 may perform rotation control of the feed roll according to the output from the speed sensor 16.

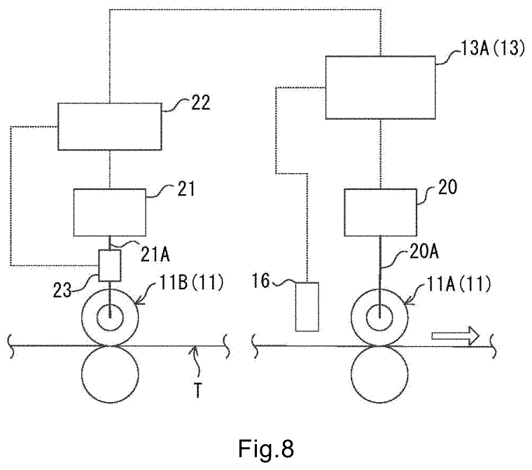

Referring to FIG. 8, a description will be given to the tension control of the coil material T in the feeding mechanism 11. The feed roll 11A is rotationally driven by an output shaft 20A of a motor (servo motor) 20. A speed control unit 13A rotates the motor 20 at a predetermined speed, and feeds the coil material T to the press machine 1 at the predetermined feed speed in consideration of the production status with the press machine 1, and the like.

The tension roll 11B is rotationally driven by an output shaft 21A of a motor (servo motor) 21. The motor 21 is torque controlled by a control signal outputted from a torque control unit 22 according to the load torque detected by a torque sensor 23 provided to the output shaft 21A. The torque control unit 22 controls the rotation of the motor 21 so as to make constant the load torque detected by the torque sensor 23 by setting a slower speed than the rotation speed of the motor 20 for rotationally driving the feed roll 11A as the initial value.

According to this, even when the feed speed of the coil material T set by the speed control unit 13A is appropriately changed, the tension roll 11B is rotationally driven in a given load state. The load imposed on the tension roll 11B is equal to the tension of the coil material T. Accordingly, the motor 22 for rotationally driving the tension roll 11B is torque controlled, so that the tension of the coil material between the feed roll 11A and the tension roll 11B is ordinarily controlled constant.

By performing such control, it is possible to keep the tension of the coil material between the feed roll 11A and the tension roll 11B constant at a high responsiveness with respect to the change in speed of the coil material, and it is possible to suppress the looseness of the coil material T between the rolls. As a result of this, it becomes possible to perform engravement on the coil material by the laser heads 12 disposed between the feed roll 11A and the tension roll 11B with a high precision.

With the tension control generally performed for a rolled film material, or the like, the tension of the film between rolls is detected, thereby controlling the difference in rotation speed of the preceding-stage and subsequent-stage rolls. According to this, the speed responsiveness with respect to the fluctuations in tension is reduced, so that the tension cannot be kept constant at a high responsiveness.

As shown in FIG. 8, the tension roll 11B is torque controlled, thereby controlling the tension of the coil material T. This eliminates the necessity of placing a tension detector between the feed roll 11A and the tension roll 11B. For this reason, it becomes possible to sufficiently ensure the space for arranging a plurality of laser heads 12 in a row between the feed roll 11A and the tension roll 11B.

Further, as shown in FIG. 7, also when the laser heads 12 are arranged on both the front and back surface sides with respect to the coil material T between the feed roll 11A and the tension roll 11B, respectively, it is possible to perform high-precision laser engraving on both the front and back surfaces of the coil material T suppressed from being loosened. When laser engraving is tried to be performed on both the front and back surfaces of the coil material T at the same time, the coil material must be suspended in the air between the rolls. However, the looseness of the coil material T between the rolls is suppressed, and hence it is possible to perform laser engraving on the front and back surfaces with the equal precision.

As described previously, when the laser heads 12 are disposed on both the front and back surface sides of the coil material T, respectively, the feeding posture of the coil material T facing the laser heads 12 may be horizontal or vertical, or may be in an obliquely inclined state.

When the feeding posture of the tab T is set horizontal, the laser heads 12 are arranged above and below the coil material T. In this case, the spaces on the left and right sides of the coil material T can be saved. When the feeding posture of the coil material T is set vertical, the laser heads 12 are arranged on the left and right sides of the coil material T. In this case, the risk is reduced that the dust (such as an aluminum powder or fumes) generated by irradiating the coil material T with a laser beam may drop on the coil material T or on the lens of the laser head.

For the laser beam sources of the laser heads 12, various ones such as a fiber laser, a UV laser, or a CO₂ laser can be used according to the uses. The fiber laser is a laser of a system using a fiber as a laser medium, and is at a low cost, has a high space efficiency, and tends to introduce a laser beam directly into an optical fiber, and to transmit the laser beam to the target position. For this reason, the fiber laser is generally used as a laser marker.

The UV laser is a laser capable of applying a laser beam in a short wavelength region. The organic matter of the surface coating of the coil material T is irradiated with a laser beam with a short wavelength, thereby enabling engravement due to breakage of the molecular structure of the surface coating. According to this, it is possible to perform engravement with less residue. The CO₂ laser is a laser capable of applying a laser beam with a long wavelength, and is low in absorptivity to aluminum of the base material of the coil material T, and hence enables engravement of suppressing the change in quality of the base material, and selectively heating only the surface coating.

As described up to this point, the laser engraving device 10 in accordance with the second embodiment of the present invention is excellent in speed responsiveness with respect to the fluctuations in tension of the coil material T, so that looseness of the coil material T is less likely to be caused between the feed roll 11A and the tension roll 11B. For this reason, it is possible to ensure the flat surface of the coil material T for performing laser engraving, which enables high-precision engravement.

Further, it is not necessary to support the coil material T between the feed roll 11A and the tension roll 11B. For this reason, it is possible to sufficiently ensure the space for arranging a plurality of laser heads 12 in a row therein, and it is possible to arrange the laser heads 12 on both the front and back surface sides of the coil material T, and to perform simultaneous engravement on the front and back surfaces with a high precision.

### Third Embodiment

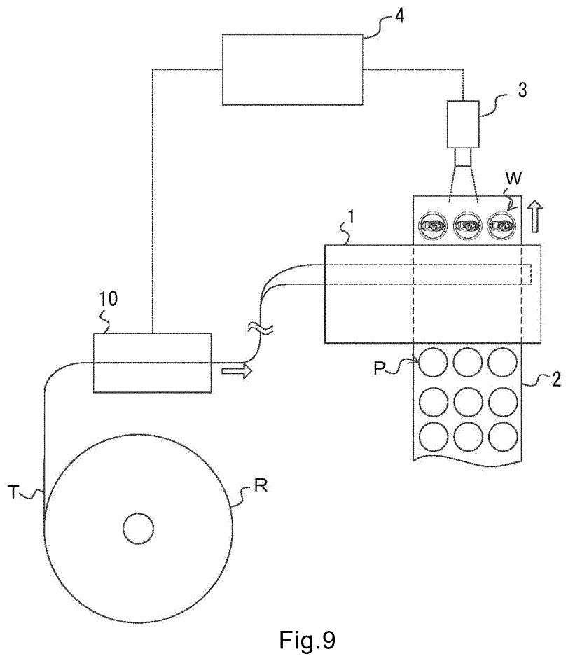

In FIG. 9, the common portions to FIG. 1 will not be described.

In a third embodiment, as shown in FIG. 9, the tab after molding discharged from the press machine 1 is shot as a tabbed can lid product W by an inspection camera 3. The image of the can lid product W obtained by the inspection camera 3 is the image for inspecting the engraving position in the molded tab. The obtained image is transmitted to a control unit 4. The control unit 4 processes the image obtained by the inspection camera 3, and determines the shift amount between the position to be subjected to engravement and the actual engraving position in the molded tab, thereby controlling the engraving timing of the laser head in the laser engraving device 10 according to the shift amount.

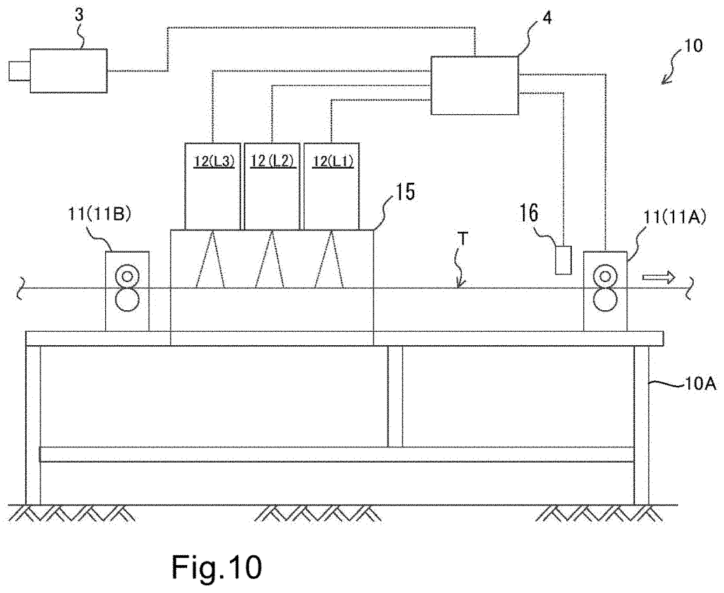

A laser engraving device 10 in the third embodiment includes, as shown in FIG. 10, a feeding mechanism 11 (a feed roll 11A and a tension roll 11B) for feeding a coil material T in the direction of an arrow at a predetermined speed, laser heads 12 (a first laser head L1, a second laser head L2, and a third laser head L3) for irradiating the coil material T fed at the predetermined speed with a laser beam, and performing engravement for each tab to be molded, and a control unit 4 for controlling the laser heads 12.

In the example shown, the laser engraving device 10 includes a base unit 10A. On the base unit 10A, a feeding mechanism 11 or a laser irradiation unit 15 equipped with the laser heads 12 is disposed. Further, the control unit 4 is disposed on a control board or the like not shown to be disposed on the base unit 10A.

The laser engraving device 10 is equipped with a speed sensor 16 for measuring the feed speed of the coil material T in a non-contact manner. For the speed sensor 16, a laser doppler speed meter for irradiating the coil material T with a laser beam, and measuring the feed speed of the coil material T in a non-contact manner can be used. The speed sensor 16 is preferably provided in the vicinity of the feed roll 11A. When the speed sensor 16 is arranged close to the feed roll 11A, the speed sensor 16 measures the feed speed in a non-contact manner with respect to the coil material T close to the feed roll 11A and with less vibration, which enables high-precision measurement. The output from the speed sensor 16 is transmitted to the control unit 4. The control unit 4 controls the engraving timing of the laser head 12 according to the output from the speed sensor 16 and the foregoing shift amount.

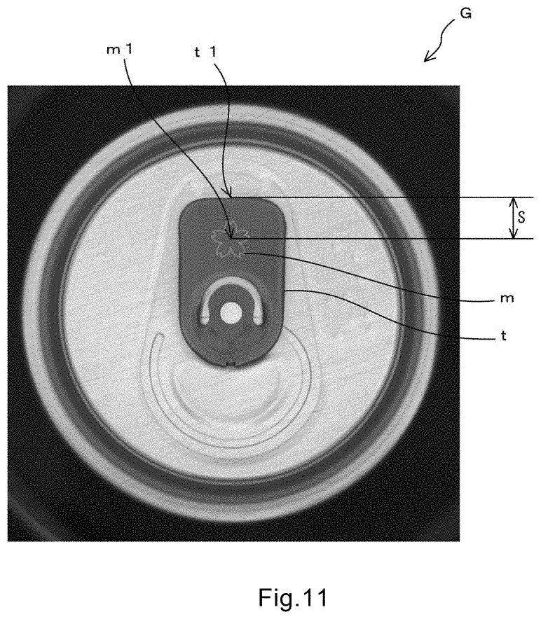

A specific example will be described regarding the shift correction of the engraving position by the control unit 4. FIG. 11 shows an image G of the tabbed can lid shoot by the inspection camera 3. The image G is subjected to image processing at the control unit 4, and is superimposed on an appropriate dimensional coordinate. Thus, a tab t in the image G is extracted, thereby determining the coordinate of the one end position t1 of the tab t. Further, an engravement m in the image G is extracted, thereby determining the coordinate of a center position ml of the engravement m. As a result of this, it is possible to determine the distance S between the one end position t1 of the tab t and the center position ml of the engravement m in the tab t. For the distance S, the predetermined distance when the center position ml is present at the position to be subjected to engravement is previously stored. The control unit 4 compares the predetermined distance with the distance S determined in the image processing, and recognizes the difference as the shift amount.

The image G is obtained by the inspection camera 3 every time when the can lid product W is fed out from the press machine 1. When the control unit 4 determines the shift amount as described previously, the control unit 4 controls the engraving timing of the laser head 12 based on the output from the speed sensor 16 so as to make the shift amount zero. Further, the control unit 4 may control the feeding mechanism 11 (the feed roll 11A) so that the feed speed may become a predetermined speed based on the output from the speed sensor 16.

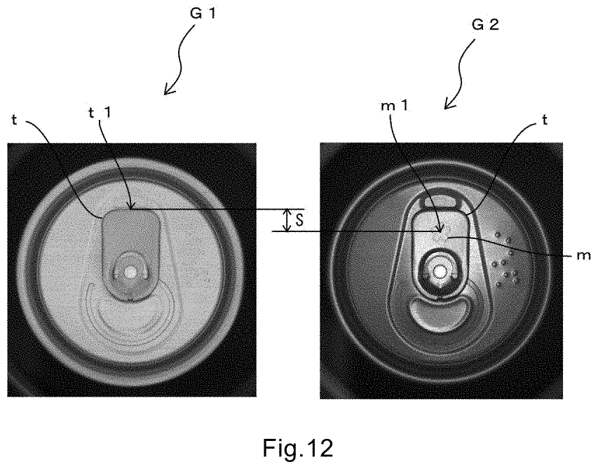

FIG. 12 shows another specific example regarding the shift correction of the engraving position. In this example, the inspection camera 3 continuously obtains the images of the can lid bound with a molded tab under the imaging conditions capable of extracting the contour of the tab t at a high contrast and under the imaging conditions capable of extracting the engravement at a high contrast. An image G1 and an image G2 of the two continuously obtained images are subjected to image processing at the control unit 4, and are superimposed on one dimensional coordinate. Then, the tab t in the image G1 is extracted, and the coordinate of the one end position t1 of the tab t is determined, and the engravement m in the image G2 is extracted, and the coordinate of the center position ml of the engravement m is determined. As a result of this, as with the foregoing example, the distance S between the one end position t1 of the tab t and the center position ml of the engravement m in the tab t can be determined. The subsequent operation of the control unit 4 is the same as that of the foregoing example.

Further, for the images G, G1, and G2, shooting is performed with the center position ml of the engravement m in agreement with the shot image center (the optical axis center of the lens) of the inspection camera 3. As a result, it is possible to suppress the error due to the lens aberration and to determine the shift amount with high precision.

Further, when the two images G1 and G2 are continuously shot as described previously, with one image G1, the inspection of flaw or dirt of the can lid is performed. As a result, it is possible to perform the inspection of the engraving position and the inspection of flaw or dirt of a product after molding in a unified way. This can simplify the inspection step and the inspection system. A description has been given to the example in which the inspection of flaw or dirt is performed with one of the two images G1 and G2. However, as shown in FIG. 11, also when the shift amount is determined with one image G, the shooting conditions are appropriately adjusted. As a result, it is possible to perform the inspection of flaw or dirt of a product after molding with one image G.

In the foregoing description, as the press machine 1, a conversion press was used. However, the following is also acceptable: with one press machine, molding of only a tab is performed, and with another press machine, a can lid is molded, which is bound with the tab after molding. In this case, the coil material is fed at a predetermined speed to a press machine for molding a tab. The coil material fed at the predetermined speed is irradiated with a laser beam, thereby performing engravement for each tab. Then, the tab after molding discharged from the press machine is shot by an inspection camera. The image obtained by the inspection camera is processed, and the shift amount between the position to be subjected to engravement and the actual engraving position is determined. Thus, the engraving timing of the laser head is controlled according to the shift amount. In that case, the engraving position is detected with the molded tab yet not detached from the coil material, and the molded tab is fed to another press machine while not being separated from the coil material.

Up to this point, the embodiments of the present invention were described in details by reference to the accompanying drawings. However, the specific configuration is not limited to the embodiments, and even the changes and the like of the design within the scope not departing from the gist of the present invention are included in the present invention. Further, the respective embodiments can be combined by applying the mutual technologies unless the objects, configurations, and the like particularly have contradiction or a problem.

1. A device for performing laser engraving on a coil material to be fed to a press machine for molding a part of a can,
the device comprising:
a feeding mechanism for feeding the coil material at a predetermined speed;
a laser head for irradiating the coil material fed at the predetermined speed with a laser beam, and performing engravement for each formed object; and
a data communication unit for switching engraving data of the laser head,
wherein the data communication unit collectively switches a plurality of engraving data to be subjected to engravement on a plurality of formed objects, and the laser head continuously performs engravement of the plurality of engraving data on each prescribed position of the coil material.

2. The laser engraving device according to claim 1, wherein the plurality of engraving data include different engravement contents.

3. The laser engraving device according to claim 1 or 2, comprising a plurality of the laser heads,
wherein the data communication unit switches a plurality of engraving data for each of a plurality of the laser heads.

4. The laser engraving device according to claim 3,
wherein for the plurality of the laser heads, engraving positions under charge of respective laser heads are sequentially segmented along a feed direction of the coil material,
for one of the laser heads, a plurality of engraving data to be subjected to engravement in each segment are subjected to engravement during a period during which a segment of an engraving position under charge of the laser head itself passes through an engraving area of the laser head itself, and the engraving data is switched until a segment of a next engraving position under charge of the laser head itself enters an engraving area of the laser head itself.

5. The laser engraving device according to claim 4,
wherein a plurality of the laser heads are arranged along a longitudinal direction of the coil material.

6. The laser engraving device according to claim 3,
wherein for a plurality of the laser heads, engraving positions under charge of the respective laser heads are segmented for each row of formed objects to be molded in the coil material.

7. The laser engraving device according to claim 1,
wherein the formed object is a tab of a can lid.

8. An engravement method for performing laser engraving on a coil material to be fed to a press machine for molding a part of a can,
the method comprising:
a laser engraving step of irradiating the coil material fed at a predetermined speed to the press machine with a laser beam, and performing engravement on each formed object by a laser head; and
a data communication step of switching engraving data of the laser head,
wherein in the data communication step, a plurality of engraving data to be subjected to engravement on a plurality of formed objects are collectively switched, and in the laser engraving step, a plurality of engraving data are continuously subjected to engravement at positions at which the formed objects are respectively molded.

9. An engraving device for performing laser engraving on a coil material to be fed to a press machine for molding a part of a can,
the device comprising:
a feeding mechanism for feeding the coil material at a predetermined speed; and
a laser head for irradiating the coil material fed at the predetermined speed with a laser beam, and performing engravement for each formed object,
wherein the feeding mechanism includes:
a feed roll provided on a downstream side in a coil material feed direction of the laser head, and for controlling a feed speed of the coil material; and
a tension roll provided on an upstream side in the coil material feed direction of the laser head, and for applying a tension to the coil material,
wherein the tension roll performs torque control of a motor for driving a roll so that a load imposed on the roll may become constant.

10. The laser engraving device according to claim 9,
wherein the laser heads are arranged on both front and back surface sides with respect to the coil material between the feed roll and the tension roll, respectively.

11. The laser engraving device according to claim 9,
wherein a speed sensor for measuring a feed speed of the coil material is provided in the vicinity of the feed roll, and an engraving timing of the laser head is controlled according to an output from the speed sensor.

12. The laser engraving device according to claim 9,
wherein the feeding posture of the coil material facing the laser head is horizontal.

13. The laser engraving device according to claim 9,
wherein the feeding posture of the coil material facing the laser head is vertical.

14. The laser engraving device according to claim 9,
wherein the formed object is a tab of a can lid.

15. An engraving device for performing laser engraving on a coil material to be fed to a press machine for molding a part of a can,
the device comprising:
a feeding mechanism for feeding the coil material to the press machine at a predetermined speed;
a laser head for irradiating the coil material fed at the predetermined speed with a laser beam, and performing engravement for each formed object;
an inspection camera for shooting the formed object discharged from the press machine, and obtaining an image for inspecting an engraving position in the formed object; and
a control unit for processing the image obtained by the inspection camera, determining a shift amount between a position to be subjected to engravement and an actual engraving position, and controlling an engraving timing of the laser head according to the shift amount.

16. The laser engraving device according to claim 15,
wherein the control unit determines a distance between one end of the formed object and a center position of an engravement, and compares the distance with a predetermined distance, thereby determining the shift amount.

17. The laser engraving device according to claim 16,
wherein the inspection camera matches a shot image center with the center position of the engravement.

18. The laser engraving device according to claim 15,
wherein the control unit processes one image obtained by the inspection camera, and determines the shift amount.

19. The laser engraving device according to claim 15,
wherein the inspection camera obtains at least two images, and the control unit determines one end position of the formed object with one image obtained by the inspection camera, and determines the center position of the engravement with the other image.

20. The laser engraving device according to claim 15,
wherein the press machine is a conversion press for performing molding and binding of a plurality of formed objects, and
the inspection camera obtains the image in a bound product.

21. The laser engraving device according to claim 15,
wherein the control unit performs inspection of flaw or dirt of the product with the image.

22. The laser engraving device according to claim 15,
wherein a speed sensor for measuring a feed speed of the coil material in a non-contact manner is provided, and engraving timing of the laser head is controlled based on an output from the speed sensor.

23. The laser engraving device according to claim 15,
wherein the formed object is a tab of a can lid.

24. A device for manufacturing a tabbed can lid, comprising:
a press machine for performing molding of a tab and performing molding of a can lid, and performing binding of the molded tab and can lid;
a feeding mechanism for feeding a coil material at a predetermined speed to the press machine;
a laser head for irradiating the coil material fed at the predetermined speed with a laser beam, and performing engravement on each tab to be molded;
an inspection camera for shooting a tabbed can lid after molding discharged from the press machine, and obtaining an image for inspecting an engraving position in a molded tab; and
a control unit for processing the image obtained by the inspection camera, and determining a shift amount between a position to be subjected to engravement and an actual engraving position, thereby controlling an engraving timing of the laser head according to the shift amount.

25. A method for manufacturing a tabbed can lid, comprising:
feeding a coil material at a predetermined speed to a press machine;
irradiating the coil material fed at the predetermined speed with a laser beam, and performing engravement on each tab to be molded by a laser head;
performing molding of the tab, and performing molding of a can lid, and performing binding of the molded tab and can lid by the press machine;
shooting a tabbed can lid after molding discharged from the press machine, and obtaining an image for inspecting an engraving position in the molded tab; and
processing the obtained image, and determining a shift amount between a position to be subjected to engravement and an actual engraving position, thereby controlling an engraving timing of the laser head according to the shift amount.
